(19) United States
(12) Patent Application Publication
(10) Pub. No.: US 2014/0247252 A1
(43) Pub. Date: Sep. 4, 2014

(54) FLEXIBLE DISPLAY DEVICE AND METHOD AND APPARATUS FOR CONTROLLING THE SAME

(71) Applicant: SAMSUNG DISPLAY CO., LTD., Yongin-City (KR)

(72) Inventor: Ah-Ram Lee, Yongin-City (KR)

(73) Assignee: SAMSUNG DISPLAY CO., LTD., Yongin-City (KR)

(21) Appl. No.: 13/959,718

(22) Filed: Aug. 5, 2013

(30) Foreign Application Priority Data
Mar. 4, 2013 (KR) 10-2013-0022968

(51) Int. Cl. G09G 3/20

(52) U.S. Cl. CPC G09G 3/20
USPC 345/204

(57) ABSTRACT

A flexible display device and a method and apparatus for controlling the same. An apparatus for controlling a display device includes the display device formed of a foldable material and folded along at least two parallel virtual folding lines, and a control unit for controlling a display of the display device based on a folded position and a folding direction of the display device, wherein the display device is configured to be foldable in a first direction at a first folding line, and is configured to be foldable in a second direction that is opposite to the first direction at a second folding line adjacent to the first folding line, wherein the first folding line is any one of the at least two parallel virtual folding lines, and the second folding line is a remaining one of the at least two parallel virtual folding lines.

### CROSS-REFERENCE TO RELATED APPLICATION

This application claims priority to and the benefit of Korean Patent Application No. 10-2013-0022968, filed on Mar. 4, 2013, in the Korean Intellectual Property Office, the disclosure of which is incorporated herein in its entirety by reference.

### BACKGROUND

1. Field

The following description relates to a flexible display device and a method and apparatus for controlling the same.

2. Description of the Related Art

Along the path of advancement of display technology, display devices that are flexible or shape-changeable during use, such as by folding, rolling into a roll (or cylindrical) shape, stretching like a rubber band, or the like, have been researched and developed. Because these display devices are changeable (e.g., bendable) into various suitable shapes, they may serve as large display devices but may also be reduced in size for ease of carrying.

Such flexible or shape-changeable display devices can be changed (e.g., bent or folded) not only into preset shapes but also into various suitable shapes to meet demands of users or circumstances in which the display devices are used. However, depending on the bending or shape-change of a flexible display device, the performance of the display device may vary, or the characteristics of the display device may be deteriorated.

Thus, even though a display device is changed in its shape (e.g., folded or unfolded) according to circumstances, reliability and stability of the display device needs to be secured by minimizing or reducing a fluctuation in the performance of the display device and preventing damage to the display device. In addition, a display area of the display device needs to be controlled in response to a changed shape (e.g., a folding or unfolding) of the display device.

### SUMMARY

Aspects of the embodiments of the present invention are directed toward a foldable flexible display device and a method and apparatus for controlling the same.

Additional aspects will be set forth in part in the description which follows and, in part, will be apparent from the description, or may be learned by practice of the presented embodiments.

According to an embodiment of the present invention, there is provided an apparatus for controlling a display device, the apparatus including: the display device formed of a foldable material and folded along at least two parallel virtual folding lines; and a control unit for controlling a display of the display device based on a folded position and a folding direction of the display device, wherein the display device is configured to be foldable in a first direction at a first folding line, and is configured to be foldable in a second direction that is opposite to the first direction at a second folding line adjacent to the first folding line, wherein the first folding line is any one of the at least two parallel virtual folding lines, and the second folding line is a remaining one of the at least two parallel virtual folding lines.

The control unit may include: a recognition unit for recognizing whether the display device is folded; and an active area setting unit for setting a whole area of a display unit of the display device as an active area when the display device is unfolded and setting a portion of the whole area of the display unit as the active area when the display device is folded along the at least two parallel virtual folding lines.

The active area may be identified by the at least two parallel virtual folding lines.

The control unit may further include a display control unit for displaying an image on the active area based on the folded position and the folding direction.

The display device may be a one-surface light-emitting display device, the first direction may be a direction in which a light-emitting surface of the display device is oriented inwards when the display device is folded, and the second direction may be a direction in which a non-light-emitting surface of the display device is oriented inwards when the display device is folded.

The display device may be configured to be foldable in the second direction along a first outer folding line, which is closest to one side of the display device, from among the at least two parallel virtual folding lines.

The active area setting unit may be configured to set an area between the first outer folding line and the one side of the display device as the active area.

The number of folds of the display device may be an even number, and accordingly, when the display device is folded, a portion of the display unit may be exposed on one surface of the folded display device.

The first outer folding line, which is closest to a one side of the display device, and a second outer folding line, which is closest to another side of the display device that is opposite to the one side thereof, from among the at least two parallel virtual folding lines, may be used to fold the display device in the second direction.

The active area setting unit may be configured to set an area between the first outer folding line and the one side of the display device as a first active area and to set an area between the second outer folding line and the other side of the display device as a second active area.

The number of folds of the display device may be an odd number, and accordingly, when the display device is folded, a portion of the display unit may be exposed on each of both surfaces of the folded display device.

The display device may be an organic light-emitting display device.

According to another embodiment of the present invention, there is provided a method of controlling a display device formed of a foldable material, the method including: recognizing folding of the display device along at least two parallel virtual folding lines on the display device; and controlling a display on the display device based on the recognized folded position and a folding direction, wherein the display device is folded in a first direction at a first folding line, and is folded in a second direction that is opposite to the first direction at a second folding line adjacent to the first folding line, wherein the first folding line is any one of the at least two parallel virtual folding lines, and the second folding line is a remaining one of the at least two parallel virtual folding lines.

The controlling may include setting a whole area of a display unit of the display device as an active area when the display device is unfolded and setting a portion of the whole area of the display unit as the active area based on the recognized folded position and the folding direction when the display device is folded along the at least two parallel virtual folding lines.

The active area may be identified by the at least two parallel virtual folding lines.

The controlling may further include displaying an image on the active area.

The display device may be a one-surface light-emitting display device, the first direction is a direction in which a light-emitting surface of the display device is oriented inwards when the display device is folded, and the second direction is a direction in which a non-light-emitting surface of the display device is oriented inwards when the display device is folded.

The display device may be folded in the second direction along a first outer folding line, which is closest to a one side of the display device, from among the at least two parallel virtual folding lines.

The setting of the active area may include setting an area between the first outer folding line and the one side of the display device as the active area.

The number of folds of the display device may be an even number, and accordingly, when the display device is folded, portion of the display unit may be exposed on one surface of the folded display device.

The first outer folding line, which is closest to a one side of the display device, and a second outer folding line, which is closest to another side of the display device that is opposite to the one side thereof, from among the at least two parallel virtual folding lines, may be used to fold the display device in the second direction.

The setting of the active area may include setting an area between the first outer folding line and the one side of the display device as a first active area and setting an area between the second outer folding line and the other side of the display device as a second active area.

The number of folds of the display device may be an odd number, and accordingly, when the display device is folded, portion of the display unit may be exposed on each of both surfaces of the folded display device.

The display device is an organic light-emitting display device.

According to an embodiment of the present invention, there is a provided a display device formed of a foldable material and including a display unit capable of displaying an image thereon, the display device configured to be foldable in a first direction at a first folding line, and configured to be foldable in a second direction that is opposite to the first direction at a second folding line adjacent to the first folding line, wherein the first folding line is any one of at least two parallel virtual folding lines on the display device, and the second folding line is a remaining one of the at least two parallel virtual folding lines on the display device, wherein at least one area of the display unit of the display device is configured to display an image thereon, wherein the at least one area is exposed according to the folding of the display device.

The display device may be configured to display images on at least two separated areas of the display unit, wherein the at least two separated areas are exposed according to the folding of the display device, and the at least two separated areas display images thereon by emitting light in directions opposite to each other according to the folding of the display device.

### BRIEF DESCRIPTION OF THE DRAWINGS

The above and other features and embodiments of the present invention will become more apparent by describing in detail example embodiments thereof with reference to the attached drawings in which:

FIGS. 1(a) and 1(b) are schematic diagrams of a flexible display device, according to an example embodiment of the present invention;

FIG. 2 is a block diagram of a control unit for controlling the flexible display device, according to an example embodiment of the present invention;

FIGS. 3(a) to 3(d) are schematic diagrams for describing control of the flexible display device, according to an example embodiment of the present invention;

FIGS. 4(a) to 4(e) are schematic diagrams for illustrating control of the flexible display device, according to another example embodiment of the present invention;

FIG. 5 illustrates an application of the flexible display device, according to an example embodiment of the present invention;

FIG. 6 is a flowchart illustrating a method of controlling the flexible display device, according to an example embodiment of the present invention; and

FIG. 7 is a detailed flowchart illustrating an operation of the method of FIG. 6, according to an example embodiment of the present invention.

### DETAILED DESCRIPTION

Embodiments of the present invention may allow various suitable changes or modifications, however, specific example embodiments will be illustrated in drawings and described in detail in the specification. It should be understood that the specific embodiments do not limit the present invention to a specific disclosed form but include every modified or equivalent embodiment within the spirit and technical scope of the present invention. In the following description, well-known functions or constructions may not be described in detail because they may obscure the invention with unnecessary detail.

Although terms, such as “first” and “second,” can be used to describe various elements, the elements may not be limited by the terms. The terms can be used to differentiate a certain element from another element.

The terminology used in the application is used only to describe specific embodiments and is not meant to limit the inventive concept. An expression in the singular includes an expression in the plural unless they are clearly different from each other in a context. In the application, it should be understood that terms, such as ‘include’ and ‘have’, are used to indicate the existence of implemented feature, number, step, operation, element, part, or a combination thereof without excluding in advance the possibility of existence or addition of one or more other features, numbers, steps, operations, elements, parts, or combinations thereof.

As used herein, the term “and/or” includes any and all combinations of one or more of the associated list of items. Expressions such as “at least one of,” when preceding a list of elements, modify the entire list of elements and do not modify the individual elements of the list.

Hereinafter, the embodiments of the present invention will be described more fully with reference to the accompanying drawings, in which example embodiments of the invention are shown.

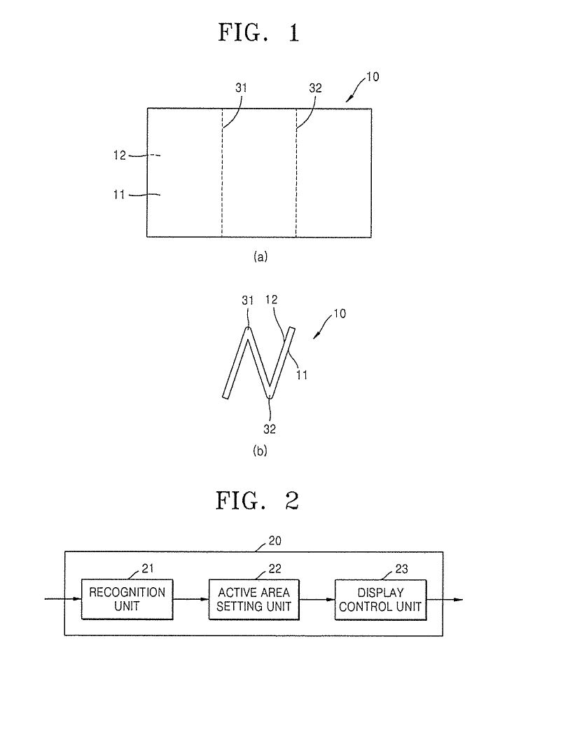

FIGS. 1(a) and 1(b) are schematic diagrams of a flexible display device 10, according to an example embodiment of the present invention.

FIG. 1(a) is a top view of the flexible display device 10 in an unfolded state. Referring to FIG. 1A, the flexible display device 10 is formed of a foldable material and may include a display unit capable of displaying an image thereon. The flexible display 10 may be folded along at least two parallel folding lines 31 and 32, all of which are virtual folding lines (hereinafter, the term “virtual folding lines” refers to folding lines that are not fixed in position and can occur at any point along the length of the flexible display device).

Because the flexible display device 10 is flexible and may be folded or rolled depending on its flexibility, it may be easily stored or carried. In addition, because various suitable screen structures are possible by displaying an image in a folded or rolled state of the flexible display device 10, it may be convenient to use the flexible display device 10.

The display unit of the flexible display device 10 may include a flexible substrate formed of a foldable plastic material or a metal foil, such as stainless steel (designated as SUS, ASTM and/or AMS) or the like, a pixel unit formed on the substrate, and a passivation film. The flexible display device 10 may be an organic light-emitting display device, a liquid crystal display device, or the like, but is not limited thereto.

Referring to FIG. 1A, the flexible display device 10 may be a one-surface light-emitting display device, which includes a light-emitting surface 11 and a non-light-emitting surface 12. The display unit of the flexible display device 10 may be an organic light-emitting display panel of a top emission type or a bottom emission type but is not limited thereto. For example, the display unit of the flexible display device 10 may be an organic light-emitting display panel of a two-surface light-emitting type. The display unit may emit light towards the light-emitting surface 11 of the flexible display device 10 to display an image.

The flexible display device 10 may be folded in a first direction at any one of the at least two parallel virtual folding lines 31 and 32 (e.g., a first folding line 31), and may be folded in a second direction that is opposite to the first direction at the other folding line (e.g., a second folding line 32 adjacent to the first folding line 31) In an embodiment, the flexible display device 10 is folded at least twice, and when the flexible display device 10 is folded along each folding line from one end thereof to the other end, directions in which the flexible display device 10 is folded may alternate. Accordingly, the flexible display device 10 may be folded in a folding screen shape.

FIG. 1(b) is a front view of the flexible display device 10 in a folded state. Referring to FIG. 1A, because the whole area of the display unit can be viewed by a user when the flexible display device 10 is unfolded, an image can be displayed on the whole area of the display unit to display the image to the user. On the contrary, referring to FIG. 1B, because only a portion of the light-emitting surface 11 is exposed outwards while the other portion thereof is folded and is not exposed outwards when the flexible display device 10 is folded, only a partial area of the display unit can be shown to the user. Accordingly, an image may be displayed only on the partial area of the display unit.

FIG. 1(b) shows for convenience of description that the flexible display device 10 is not fully folded so that the folding surfaces of the flexible display device 10 do not contact with each other; however, the embodiments of the present invention are not limited thereto. A folded angle of the flexible display device 10 may be varied according to usage requirements in which embodiments of the present invention is carried out. When the flexible display device 10 is fully folded so that the folding surfaces of the flexible display device 10 are in contact with each other, it can be easy to store and/or carry the flexible display device 10, and the flexible display device 10 can be more conveniently used while in a folded state.

FIG. 2 is a block diagram of a control unit 20 for controlling the flexible display device 10, according to an embodiment of the present invention. The flexible display device 10, according to an embodiment of the present invention, is formed of a foldable material and includes the display unit foldable along the at least two parallel virtual folding lines 31 and 32 as described above, and may further include the control unit 20 for controlling the display of the flexible display device 10 according to a folded position and a folding direction of the flexible display device 10.

Referring to FIG. 2, the control unit 20 may include a recognition unit 21, an active area setting unit 22, and a display control unit 23. The recognition unit 21 may recognize folding of the flexible display device 10. For example, the recognition unit 21 recognizes the number of folds, a folding direction, and a folded position of the flexible display device 10.

To this end, the flexible display device 10 may include a sensor for recognizing a shape change (e.g., a folding or unfolding of the display). For example, the flexible display device 10 includes at least one proximity sensor on the front surface or the rear surface thereof and recognizes folding of the flexible display device 10 by using the at least one proximity sensor. Alternatively, the flexible display device 10 may recognize folding of the flexible display device 10 by recognizing a resistance change in a substrate corresponding to a folded part of the flexible display device 10. Alternatively, the flexible display device 10 may use an acceleration sensor, an angular velocity sensor, or the like. However, the methods described above are only illustrative, and a method of recognizing the folding of the flexible display device 10 by the recognition unit 21 is not limited thereto.

The active area setting unit 22 may set the whole area of the display unit as an active area when the flexible display device 10 is unfolded and may set a portion of the display unit as the active area when the flexible display device 10 is folded along the at least two folding lines 31 and 32. The active area set by the active area setting unit 22 may be determined by the at least two folding lines 31 and 32.

The display control unit 23 may display an image on the active area set by the active area setting unit 22. For example, the display control unit 23 displays a user interface (UI) or a user experience (UX) design form suitable for the active area set by the active area setting unit 22.

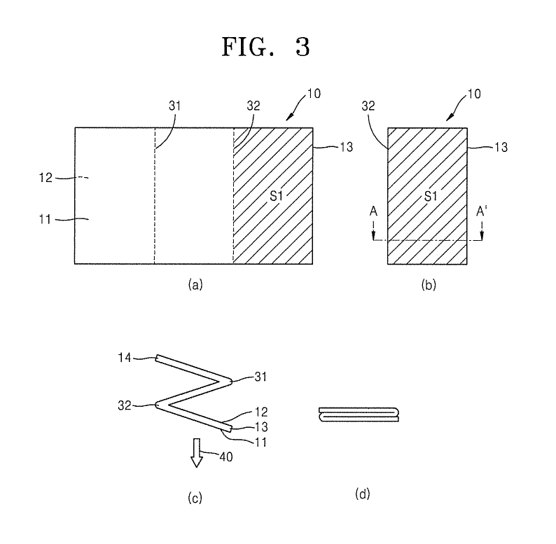

FIGS. 3(a) to 3(d) are schematic diagrams for describing control of the flexible display device 10, according to an embodiment of the present invention. Referring to FIG. 3A, the flexible display device 10 may be a one-surface light-emitting display device which includes a light-emitting surface 11 and a non-light-emitting surface. The flexible display device 10 may be folded along the at least two parallel virtual folding lines 31 and 32.

The flexible display device 10 may be folded in the first direction at the first folding line 31 and folded in the second direction that is opposite to the first direction at the second folding line 32 adjacent to the first folding line 31. The first direction may be a direction in which the light-emitting surface 11 of the flexible display device 10 is oriented inwards when the flexible display device 10 is folded, and the second direction may be a direction in which the non-light-emitting surface 12 of the flexible display device 10 is oriented inwards when the flexible display device 10 is folded.

FIG. 3(b) is a top view of the flexible display device 10 in a folded state. Although the flexible display device 10 is folded in the first direction at the first folding line 31 and folded in the second direction at the second folding line 32 in the embodiment of FIGS. 3(a) to 3D, this is only illustrative, and the present invention is not limited thereto. For example, a folding direction of the flexible display device 10 at each folding line is opposite to the shown direction. For example, the flexible display device 10 is folded in the second direction at the first folding line 31 and folded in the first direction at the second folding line 32. However, the flexible display device 10 is folded in directions opposite to each other at adjacent folding lines.

The flexible display device 10 may be folded in the second direction at a folding line (hereinafter, referred to as ‘first outer folding line’), which is closest to one side of the flexible display device 10, from among folding lines. In other words, the flexible display device 10 may be folded in the second direction at at least one of one end or the other end of the flexible display device 10. Accordingly, a portion of the display unit of the flexible display device 10 may be exposed outwards to display an image on the exposed portion of the display unit so that a user can view the image.

Referring to FIG. 3A, the flexible display device 10 may be folded in the second direction at the second folding line 32, which is closest to one side 13 of the flexible display device 10, from among the first and second folding lines 31 and 32. Accordingly, a portion S1 of the display unit of the flexible display device 10 may be exposed outwards to display an image on the exposed portion S1 of the display unit so that the user can view the image.

Referring to FIG. 3B, when the flexible display device 10 is folded, the portion S1 of the display unit may be exposed towards the front surface of the flexible display device 10 when unfolded. At this time, the recognition unit 21 of FIG. 2 may recognize the folding of the flexible display device 10.

The active area setting unit 22 may set the exposed portion S1 of the display unit as the active area based on the recognition of the recognition unit 21. For example, the active area setting unit 22 sets an area S1 between the first outer folding line (the second folding line 32 of FIG. 3A) and the one side 13 of the display unit as the active area.

Referring to FIG. 3B, the active area S1 may be identified by the second folding line 32. In more detail, the active area S1 may be identified by the second folding line 32 and the one side 13 of the flexible display device 10.

The display control unit 23 may display an image on the active area S1 set by the active area setting unit 22. The display control unit 23 may display a user interface (UI) screen suitable for the active area S1.

FIGS. 3(c) and 3(d) are cross-sectional diagrams along line A-A′ of FIG. 3B. First, referring to FIG. 3C, the folded flexible display device 10 may have a folding screen shape. The flexible display device 10 may be folded in the first direction at the first folding line 31 so that the light-emitting surface 11 is oriented inwards at the first folding line 31 and may be folded in the second direction at the second folding line 32 so that the non-light-emitting surface 12 is oriented inwards at the second folding line 32.

Accordingly, a partial area of the light-emitting surface 11 between the second folding line 32 and the one side 13 of the display unit may be exposed outwards, and this exposed partial area of the light-emitting surface 11 of the display unit may display an image thereon in a direction 40. However, even though a partial area of the non-light-emitting surface 12 between the first folding line 31 and the other side 14 of the display unit is exposed outwards, this partial area of the non-light-emitting surface 12 of the display unit may not display an image thereon outwards.

FIG. 3(c) shows for convenience of description that the flexible display device 10 is not fully folded so that the folded surfaces of the flexible display device 10 do not contact with each other; however, the embodiments of the present invention are not limited thereto. A folded angle of the flexible display device 10 may vary according to usage requirements in which embodiments of the present invention are carried out.

As shown in FIG. 3D, when the flexible display device 10 is fully folded so that the folded surfaces of the flexible display device 10 are in contact with each other, it can be easier to store and/or carry the flexible display device 10, and the flexible display device 10 can be more conveniently used while in a folded state.

In addition, when the flexible display device 10 is folded or changed in shape, as shown in FIG. 3D, is stored or carried, the flexible display device 10 may be folded in the first direction at both the first and second folding lines 31 and 32 so that the whole area of the display unit is not exposed outwards.

For example, in FIGS. 3(a) to 3D, the flexible display device 10 is folded or changed in its shape by folding the flexible display device 10 in the first direction at both the first and second folding lines 31 and 32, respectively, so that the exposed area S1 of the display unit is oriented inwards. Accordingly, the whole area of the display unit may not be exposed outwards, thereby protecting the display unit. However, because the display unit is not exposed outwards, no images may be shown to the user.

Although an embodiment where the flexible display device 10 is folded twice is shown as described above, the present invention is not limited thereto, and the flexible display device 10 may be folded four times, six times, eight times, . . . , or 2n times (where n is a positive integer), that is, the number of folds of the flexible display device 10 may be even in number. Accordingly, when the flexible display device 10 is folded, only a portion of the display unit may be exposed on one surface of the folded flexible display device 10. In this embodiment, the folded flexible display device 10 is used as a one-surface light-emitting display device having a reduced size in comparison with an unfolded state thereof.

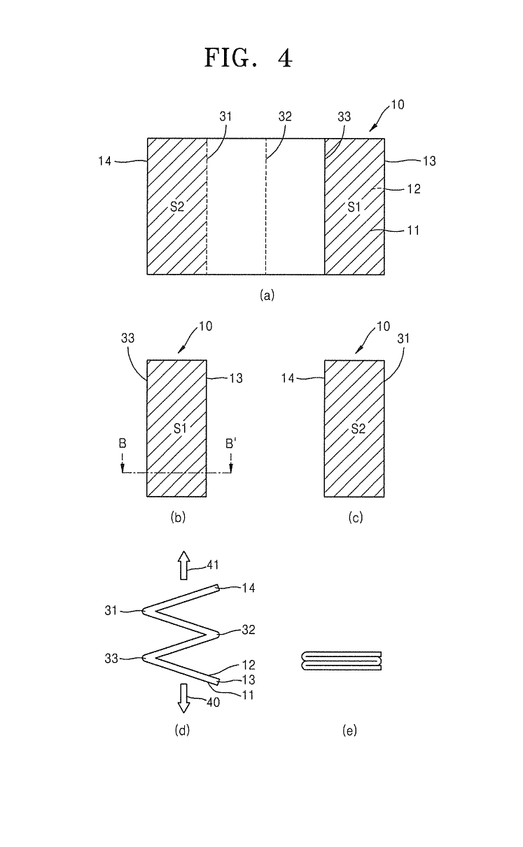

FIGS. 4(a) to 4(e) are schematic diagrams for describing control of the flexible display device 10, according to another embodiment of the present invention. Referring to FIG. 4A, the flexible display device 10 may be a one-surface light-emitting display device including the light-emitting surface 11 at the front surface thereof and the non-light-emitting surface 12 at the rear surface thereof. The flexible display device 10 may be folded along at least three parallel folding lines 31, 32, and 33, all of which are virtual folding lines.

For example, the flexible display device 10 may be folded in the second direction at the first folding line 31, folded in the first direction at the second folding line 32 adjacent to the first folding line 31, and folded in the second direction at the third folding line 33 adjacent to the second folding line 32.

As described above, the first direction may be a direction in which the light-emitting surface 11 of the flexible display device 10 is oriented inwards when the flexible display device 10 is folded, and the second direction may be a direction in which the non-light-emitting surface 12 of the flexible display device 10 is oriented inwards when the flexible display device 10 is folded.

FIGS. 4(b) and 4(c) are a top view and a bottom view, respectively, of the flexible display device 10 in a folded state. Although the embodiment of FIGS. 4(a) to 4(e) shows that the flexible display device 10 is folded in the second direction at the first folding line 31, folded in the first direction at the second folding line 32, and folded in the second direction at the third folding line 33, this is only one embodiment, and the embodiment of FIGS. 4(a) to 4(e) is not limited thereto. For example, a folding direction of the flexible display device 10 at each folding line is opposite to the shown direction. For example, the flexible display device 10 is folded in the first direction at the first folding line 31, folded in the second direction at the second folding line 32, and folded in the first direction at the third folding line 33. However, the flexible display device 10 is folded in directions opposite to each other at adjacent folding lines.

The flexible display device 10 may be folded in the second direction at a folding line (hereinafter, referred to as ‘first outer folding line’), which is closest to the one side 13 of the flexible display device 10, and at a folding line (hereinafter, referred to as ‘second outer folding line’), which is closest to the other side 14 of the flexible display device 10 that is opposite to the one side 13, from among the first to third folding lines 31, 32, and 33. In other words, the flexible display device 10 may be folded in the second direction at the two folding lines 31 and 33 located at both ends of the flexible display device 10. Accordingly, portions of the display unit may be exposed on front and back surfaces of the flexible display device 10 to display images on the exposed portions, i.e., first and second active areas, S1 and S2 of the display unit so that a user can view the images. In this embodiment, the folded flexible display device 10 is used as a two-surface light-emitting display device.

Referring to FIG. 4A, the flexible display device 10 may be folded in the second direction at the third folding line 33, which is the first outer folding line closest to the one side 13 of the flexible display device 10, and at the first folding line 31, which is the second outer folding line closest to the other side 14 of the flexible display device 10, from among the first to third folding lines 31, 32, and 33. Accordingly, portions S1 and S2 of the display unit of the flexible display device 10 may be exposed outwards, and images may be displayed on the exposed portions S1 and S2 of the display unit so that the user can view the images.

When the flexible display device 10 is folded, the exposed portion S1 of the display unit may be exposed towards the front, as perceived by a user, (shown in FIG. 4B), and the other exposed portion S2 of the display unit may be exposed towards the rear, as perceived by a user, (shown in FIG. 4C). The recognition unit 22 of FIG. 2 may recognize the folding of the flexible display device 10.

The active area setting unit 22 may set the exposed portions S1 and S2 of the display unit as the active area based on the recognition (or detection) of the recognition unit 21. For example, the active area setting unit 22 sets the exposed portion S1, between the first outer folding line (the third folding line 33 of FIG. 4A) and the one side 13 of the display unit, as a first active area and sets the exposed portion S2, between the second outer folding line (the first folding line 31 of FIG. 4A) and the other side 14 of the display unit, as a second active area.

Referring to FIG. 4B, the first active area S1 may be identified by the third folding line 33, and the second active area S2 may be identified by the first folding line 31. For example, the first active area S1 is identified by the third folding line 33 and the one side 13 of the flexible display device 10, and the second active area S2 is identified by the first folding line 31 and the other side 14 of the flexible display device 10.

The display control unit 23 may display images on the at least two first and second active areas S1 and S2 of the display unit separated from each other, which are exposed when the flexible display device 10 is folded. Each of the first and second active areas S1 and S2 may emit light in a direction opposite to the other's respective facing direction to display an image when the flexible display device 10 is folded.

For example, the display control unit 23 displays an image on each of the first and second active areas S1 and S2 set by the active area setting unit 22. For example, the display control unit 23 displays a same image on the first and second active areas S1 and S2 as in a two-surface light-emitting display device. Alternatively, the display control unit 23 may display different images on the first and second active areas S1 and S2.

FIGS. 4(d) and 4(e) are cross-sectional diagrams along line B-B′ of FIG. 4B. First, referring to FIG. 4D, the folded flexible display device 10 may have a folding screen shape. The flexible display device 10 may be folded in the second direction at the first folding line 31 so that the non-light-emitting surface 12 is oriented inwards, may be folded in the first direction at the second folding line 32 so that the light-emitting surface 11 is oriented inwards, and may be folded in the second direction at the third folding line 33 so that the non-light-emitting surface 12 is oriented inwards.

Accordingly, the first active area S1 of the display unit between the third folding line 33 and the one side 13 of the flexible display device 10 may be exposed outwards, and the exposed first active area S1 of the display unit may display an image thereon in a direction 40. In addition, the second active area S2 of the display unit between the first folding line 31 and the other side 14 of the flexible display device 10 may also be exposed outwards, and the exposed second active area S2 of the display unit may display an image thereon in a direction 41.

FIG. 4(d) shows for convenience of description that the flexible display device 10 is not fully folded so that the folded surfaces of the flexible display device 10 do not contact with each other; however, the embodiments of the present invention are not limited thereto. A folded angle of the flexible display device 10 may vary according to usage requirements in which embodiments of the present invention are carried out.

As shown in FIG. 4E, when the flexible display device 10 is fully folded so that the folded surfaces of the flexible display device 10 are in contact with each other, it may be easier to store and/or carry the flexible display device 10, and the flexible display device 10 may be more conveniently used while in a folded state.

In addition, when the flexible display device 10 is folded or changed in shape, as shown in FIG. 4E, is stored or carried, the flexible display device 10 may be folded in the first direction at the first and third folding lines 31 and 33 located at both ends of the flexible display device 10 so that the whole area of the display unit is not exposed outwards.

For example, in FIGS. 4(a) to 4E, the flexible display device 10 is folded or changed in its shape by folding the flexible display device 10 in the first direction at the first and third folding lines 31 and 33 so that the exposed areas S1 and S2 of the display unit are oriented inwards. Accordingly, the whole area of the display unit may be not exposed outwards, thereby protecting the display unit.

Although an embodiment where the flexible display device 10 is folded three times is shown as described above, the present invention is not limited thereto, and the flexible display device 10 may be folded five times, seven times, nine times, . . . , or 2n+1 times, that is, the number of folds of the flexible display device 10 may be odd in number. Accordingly, when the flexible display device 10 is folded, a portion of the display unit may be exposed on each of both surfaces of the flexible display device 10. In this embodiment, the folded flexible display device 10 may be used as a two-surface light-emitting display device having a reduced size in comparison with an unfolded state thereof.

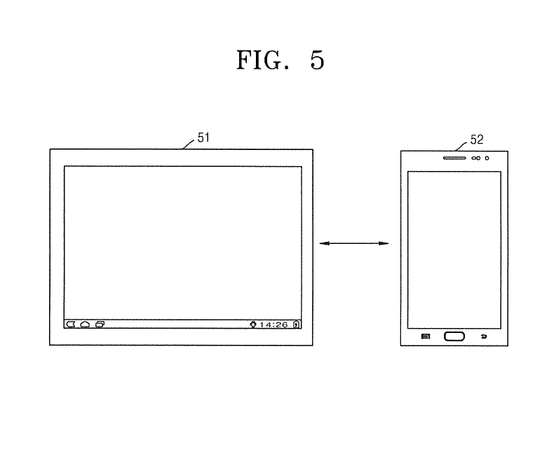

FIG. 5 illustrates an application of the flexible display device 10, according to an embodiment of the present invention. Referring to FIG. 5, the flexible display device 10 may be repeatedly changed in shape to an unfolded state 51 and a folded state 52, and accordingly, the control unit 20 of FIG. 2 may provide a UI screen suitable for each state in an active area set in each state.

For example, the control unit 20 provides a UI screen suitable for use with a large screen (e.g., as in a tablet, PC, or a TV) in the unfolded state 51 of the flexible display device 10 and provides a UI screen suitable for use with a small screen (e.g., as in a smart phone or a portable terminal) in the folded state 52 of the flexible display device 10, but the control unit 20 is not limited thereto. Accordingly, the flexible display device 10 may be used in a variety of ways depending on the changes in its shape.

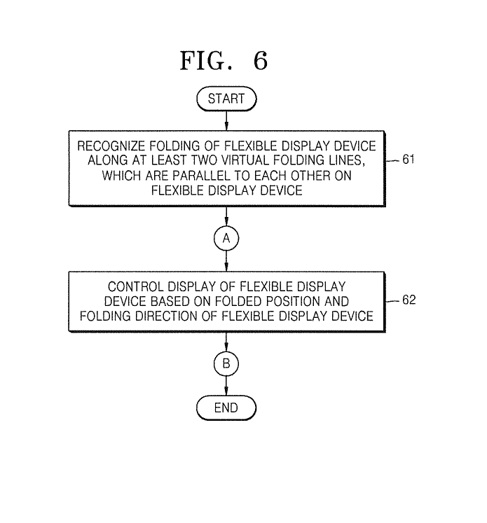

FIG. 6 is a flowchart illustrating a method of controlling the flexible display device 10, according to an embodiment of the present invention.

Referring to FIG. 6, in the method of controlling the flexible display device 10 formed of a foldable material, in operation 61, the recognition unit 21 recognizes folding of the flexible display device 10 along at least two folding lines, which are virtual folding lines and are parallel to each other on the flexible display device 10. The flexible display device 10 is folded in a first direction at a first folding line, which is any one of the at least two virtual folding lines, and folded in a second direction that is opposite to the first direction at a second folding line adjacent to the first folding line.

In this embodiment, the flexible display device 10 is a one-surface light-emitting display device, the first direction is a direction in which a light-emitting surface of the flexible display device 10 is oriented inwards when the flexible display device 10 is folded, and the second direction is a direction in which a non-light-emitting surface of the flexible display device 10 is oriented inwards when the flexible display device 10 is folded.

The flexible display device 10 may be folded in the second direction at a first outer folding line, which is closest to one side of the flexible display device 10, from among the at least two folding lines.

Alternatively, the flexible display device 10 may be folded in the second direction at the first outer folding line, which is closest to the one side of the flexible display device 10, and at a second outer folding line, which is closest to the other side of the flexible display device 10 that is opposite to the one side, from among the at least two folding lines.

In operation 62, the control unit 20 controls display of the flexible display device 10 based on a folded position and a folding direction of the flexible display device 10, which are recognized by the recognition unit 21.

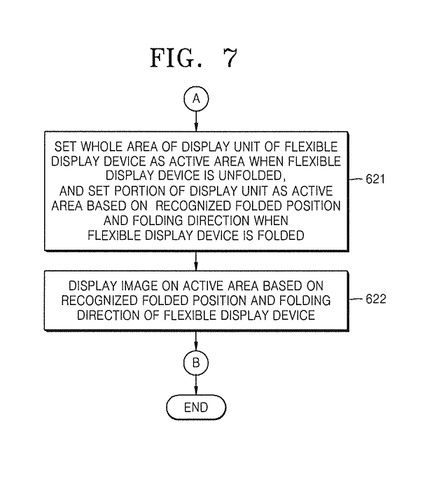

FIG. 7 is a detailed flowchart illustrating operation 62 of the method of FIG. 6.

Referring to FIG. 7, in operation 621, the active area setting unit 22 sets the whole area of the display unit of the flexible display device 10 as an active area when the flexible display device 10 is unfolded, and sets a portion of the display unit as the active area based on the folded position and the folding direction, which are recognized in operation 61, when the flexible display device 10 is folded along the at least two folding lines. The active area may be identified by the at least two folding lines.

The number of folds of the flexible display device 10 may be even in number, and accordingly, when the flexible display device 10 is folded, a portion of the display unit may be exposed on only one surface of the flexible display device 10. In this embodiment, in operation 621, the active area setting unit 22 sets the exposed partial area of the display unit as the active area.

For example, in operation 621, the active area setting unit 22 sets an area between a first outer folding line and one side of the flexible display device 10 as the active area.

The number of folds of the flexible display device 10 may be odd in number, and accordingly, when the flexible display device 10 is folded, a portion of the display unit may be exposed on each of both surfaces of the flexible display device 10. In this embodiment, the active area setting unit 22 sets the exposed partial areas of the display unit as a first active area and a second active area, in operation 621.

For example, in operation 621, the active area setting unit 22 sets an area between the first outer folding line and the one side of the flexible display device 10 as the first active area and sets an area between a second outer folding line and the other side of the flexible display device 10 as the second active.

In operation 622, the display control unit 23 displays an image on the active area set in operation 621 based on the folded position and the folding direction of the flexible display device 10, which are recognized in operation 61.

According to the embodiments of the present invention, by controlling display of a flexible display device based on a shape of the flexible display device, an image suitable for the shape of the flexible display device is displayed. For example, when the flexible display device is changed in shape (e.g., folded), a size and a shape of an area of a display unit viewed by a user are changed, and by displaying an image suitable for the changed view area to the user, one flexible display device can be used in a variety of ways.

In addition, the ability of the flexible display device to change shape (e.g., be folded) allows it to be used as a large screen while assuming a compact form factor when being carried or stored away.

In addition, because the shape of the flexible display device can be changed to a folding screen shape, reliability of characteristics of the flexible display device is improved by lowering the risk of damage to the display.

For example, when the flexible display device is folded several times in only one direction, an upper plate and a lower plate of the flexible display device expand non-uniformly, and a radius of curvature at each folded part gradually increases. Accordingly, the performance of the flexible display device may be degraded, and display quality may be degraded. However, according to the embodiments of the present invention, when the flexible display device is alternately folded in different directions, the upper plate and the lower plate of the flexible display device may expand uniformly. In addition, because a radius of curvature at each folded part is maintained constant in the flexible display device folded in a folding screen shape, damage of the flexible display device may be reduced or prevented.

While the present invention has been particularly shown and described with reference to example embodiments thereof, it will be understood by those of ordinary skill in the art that various suitable changes in form and details may be made therein without departing from the spirit and scope of the present invention as defined by the following claims, and equivalents thereof.

What is claimed is:

1. An apparatus for controlling a display device, the apparatus comprising:
the display device formed of a foldable material and folded along at least two parallel virtual folding lines; and
a control unit for controlling a display of the display device based on a folded position and a folding direction of the display device,
wherein the display device is configured to be foldable in a first direction at a first folding line, and is configured to be foldable in a second direction that is opposite to the first direction at a second folding line adjacent to the first folding line, wherein the first folding line is any one of the at least two parallel virtual folding lines, and the second folding line is a remaining one of the at least two parallel virtual folding lines.

2. The apparatus of claim 1, wherein the control unit comprises:
a recognition unit for recognizing whether the display device is folded; and
an active area setting unit for setting a whole area of a display unit of the display device as an active area when the display device is unfolded and setting a portion of the whole area of the display unit as the active area when the display device is folded along the at least two parallel virtual folding lines.

3. The apparatus of claim 2, wherein the active area is identified by the at least two parallel virtual folding lines.

4. The apparatus of claim 2, wherein the control unit further comprises a display control unit for displaying an image on the active area based on the folded position and the folding direction.

5. The apparatus of claim 2, wherein the display device is a one-surface light-emitting display device, the first direction is a direction in which a light-emitting surface of the display device is oriented inwards when the display device is folded, and the second direction is a direction in which a non-light-emitting surface of the display device is oriented inwards when the display device is folded.

6. The apparatus of claim 5, wherein the display device is configured to be foldable in the second direction along a first outer folding line, which is closest to one side of the display device, from among the at least two parallel virtual folding lines.

7. The apparatus of claim 6, wherein the active area setting unit is configured to set an area between the first outer folding line and the one side of the display device as the active area.

8. The apparatus of claim 6, wherein a number of folds of the display device is an even number, and accordingly, when the display device is folded, a portion of the display unit is exposed on one surface of the folded display device.

9. The apparatus of claim 5, wherein a first outer folding line, which is closest to a one side of the display device, and a second outer folding line, which is closest to another side of the display device that is opposite to the one side thereof, from among the at least two parallel virtual folding lines, are used to fold the display device in the second direction.

10. The apparatus of claim 9, wherein the active area setting unit is configured to set an area between the first outer folding line and the one side of the display device as a first active area and to set an area between the second outer folding line and the other side of the display device as a second active area.

11. The apparatus of claim 9, wherein a number of folds of the display device is an odd number, and accordingly, when the display device is folded, a portion of the display unit is exposed on each of both surfaces of the folded display device.

12. The apparatus of claim 1, wherein the display device is an organic light-emitting display device.

13. A method of controlling a display device formed of a foldable material, the method comprising:
recognizing folding of the display device along at least two parallel virtual folding lines on the display device; and
controlling a display on the display device based on the recognized folded position and a folding direction,
wherein the display device is folded in a first direction at a first folding line, and is folded in a second direction that is opposite to the first direction at a second folding line adjacent to the first folding line, wherein the first folding line is any one of the at least two parallel virtual folding lines, and the second folding line is a remaining one of the at least two parallel virtual folding lines.

14. The method of claim 13, wherein the controlling comprises setting a whole area of a display unit of the display device as an active area when the display device is unfolded and setting a portion of the whole area of the display unit as the active area based on the recognized folded position and the folding direction when the display device is folded along the at least two parallel virtual folding lines.

15. The method of claim 14, wherein the active area is identified by the at least two parallel virtual folding lines.

16. The method of claim 14, wherein the controlling further comprises displaying an image on the active area.

17. The method of claim 14, wherein the display device is a one-surface light-emitting display device, the first direction is a direction in which a light-emitting surface of the display device is oriented inwards when the display device is folded, and the second direction is a direction in which a non-light-emitting surface of the display device is oriented inwards when the display device is folded.

18. The method of claim 17, wherein the display device is folded in the second direction along a first outer folding line, which is closest to a one side of the display device, from among the at least two parallel virtual folding lines.

19. The method of claim 18, wherein the setting of the active area comprises setting an area between the first outer folding line and the one side of the display device as the active area.

20. The method of claim 18, wherein a number of folds of the display device is an even number, and accordingly, when the display device is folded, portion of the display unit is exposed on one surface of the folded display device.

21. The method of claim 17, wherein a first outer folding line, which is closest to a one side of the display device, and a second outer folding line, which is closest to another side of the display device that is opposite to the one side thereof, from among the at least two parallel virtual folding lines, are used to fold the display device in the second direction.

22. The method of claim 21, wherein the setting of the active area comprises setting an area between the first outer folding line and the one side of the display device as a first active area and setting an area between the second outer folding line and the other side of the display device as a second active area.

23. The method of claim 21, wherein a number of folds of the display device is an odd number, and accordingly, when the display device is folded, portion of the display unit is exposed on each of both surfaces of the folded display device.

24. The method of claim 13, wherein the display device is an organic light-emitting display device.

25. A display device formed of a foldable material and comprising a display unit capable of displaying an image thereon,
the display device configured to be foldable in a first direction at a first folding line, and configured to be foldable in a second direction that is opposite to the first direction at a second folding line adjacent to the first folding line,
wherein the first folding line is any one of at least two parallel virtual folding lines on the display device, and the second folding line is a remaining one of the at least two parallel virtual folding lines on the display device, wherein at least one area of the display unit of the display device is configured to display an image thereon, wherein the at least one area is exposed according to the folding of the display device.

26. The display device of claim 25, wherein the display device is configured to display images on at least two separated areas of the display unit, wherein the at least two separated areas are exposed according to the folding of the display device, and the at least two separated areas display images thereon by emitting light in directions opposite to each other according to the folding of the display device.
